(19) United States
(12) Patent Application Publication
(10) Pub. No.: US 2015/0363503 A1
(43) Pub. Date: Dec. 17, 2015

(54) SYSTEM AND METHODS FOR PROPOSING MEDIA FOR A WEB PAGE

(71) Applicant: Go Daddy Operating Company, LLC, Scottsdale, AZ (US)

(72) Inventor: Matthew Scheuerman, Queen Creek, AZ (US)

(21) Appl. No.: 14/303,439

(22) Filed: Jun. 12, 2014

(51) Int. Cl. G06F 17/30; G06F 3/0484; G06F 3/0482; H04L 29/06; G06F 17/22

(52) U.S. Cl. CPC G06F 17/30893; G06F 17/3005; H04L 67/42; G06F 17/2247; G06F 3/0482; G06F 17/30274; G06F 3/04842

(57) ABSTRACT

Systems and methods provide a website builder tool capable of searching an image database to provide one or more proposed items of media for inclusion in a web page. The proposed media may correspond to one or more of the following: A keyword within the text input by the user for the web page; A language of the text; A theme genre assigned to the web page; or A geographical region associated with the web page. The proposed media can be presented to a user via an media selection user interface for selection as web page media for inclusion in the web page.

### FIELD OF THE INVENTION

The present invention generally relates to media for a web page, and, more specifically, to systems and methods for efficiently and effectively proposing media for a web page.

### BACKGROUND OF THE INVENTION

The Internet comprises a vast number of computers and computer networks that are interconnected through communication links. The interconnected computers exchange information using various services. In particular, a server computer system, referred to herein as a server, web server, server device, or the like, may connect through the Internet to a remote client computer system and may send, to the remote client computer system upon request, one or more websites containing one or more graphical and textual web pages of information. A request is made to the web server by visiting the website's address, known as a Uniform Resource Locator (“URL”). Upon receipt, the requesting device can display the web pages. The request and display of the websites are typically conducted using a browser being an application program that effects the requesting of web pages and the displaying of web pages.

Browsers are able to locate specific websites because each website, resource, and computer on the Internet has a unique Internet Protocol (IP) address. Presently, there are two standards for IP addresses. The older IP address standard, often called IP Version 4 (IPv4), is a 32-bit binary number, which is typically shown in dotted decimal notation, where four 8-bit bytes are separated by a dot from each other (e.g., 64.202.167.32). The notation is used to improve human readability. The newer IP address standard, often called IP Version 6 (IPv6) or Next Generation Internet Protocol (IPng), is a 128-bit binary number. The standard human readable notation for IPv6 addresses presents the address as eight 16-bit hexadecimal words, each separated by a colon (e.g., 2EDC:BA98:0332:0000:CF8A:000C:2154:7313).

IP addresses, however, even in human readable notation, are difficult for people to remember and use. A URL is much easier to remember and may be used to point to any computer, directory, or file on the Internet. A browser is able to access a website on the Internet through the use of a URL. The URL may include a Hypertext Transfer Protocol (HTTP) request combined with the website's Internet address, also known as the website's domain name. An example of a URL with a HTTP request and domain name is: http://www.companyname.com. In this example, the “http” identifies the URL as a HTTP request and the “companyname.com” is the domain name. A domain can further host multiple websites that can be accessed by appending character strings that constitute the full path to the website's files. For example, the domain for FACEBOOK includes one or more websites, as the term is used herein, for each of its users. A user-specific website is requested by appending a directory to the FACEBOOK main URL, e.g.: http://www.facebook.com/username.

Domain names are much easier to remember and use than their corresponding IP addresses. The Internet Corporation for Assigned Names and Numbers (ICANN) approves some Generic Top-Level Domains (gTLD) and delegates the responsibility to a particular organization (a “registry”) for maintaining an authoritative source for the registered domain names within a TLD and their corresponding IP addresses. For certain TLDs (e.g., .biz, .info, .name, and .org) the registry is also the authoritative source for contact information related to the domain name and is referred to as a “thick” registry. For other TLDs (e.g., .com and .net) only the domain name, registrar identification, and name server information is stored within the registry, and a registrar is the authoritative source for the contact information related to the domain name. Such registries are referred to as “thin” registries. Most gTLDs are organized through a central domain name Shared Registration System (SRS) based on their TLD.

The process for registering a domain name with .com, .net, .org, and some other TLDs allows an Internet user to use an ICANN-accredited registrar to register their domain name. For example, if an Internet user, John Doe, wishes to register the domain name “mycompany.com,” John Doe may initially determine whether the desired domain name is available by contacting a domain name registrar. The Internet user may make this contact using the registrar's web page and typing the desired domain name into a field on the registrar's web page created for this purpose. Upon receiving the request from the Internet user, the registrar may ascertain whether “mycompany.com” has already been registered by checking the SRS database associated with the TLD of the domain name. The results of the search then may be displayed on the web page to thereby notify the Internet user of the availability of the domain name. If the domain name is available, the Internet user may proceed with the registration process. Otherwise, the Internet user may keep selecting alternative domain names until an available domain name is found. Domain names are typically registered for a period of one to ten years with first rights to continually re-register the domain name.

The information on web pages is in the form of programmed source code that the browser interprets to determine what to display on the requesting device. The source code may include document formats, objects, parameters, positioning instructions, and other code that is defined in one or more web programming or markup languages. One web programming language is HyperText Markup Language (“HTML”), and all web pages use it to some extent. HTML uses text indicators called tags to provide interpretation instructions to the browser. The tags specify the composition of design elements such as text, media, images, shapes, hyperlinks to other web pages, programming objects such as JAVA applets, form fields, tables, and other elements. The web page can be formatted for proper display on computer systems with widely varying display parameters, due to differences in screen size, resolution, processing power, and maximum download speeds.

For Internet users and businesses alike, the Internet continues to be increasingly valuable. More people use the Web for everyday tasks, from social networking, shopping, banking, and paying bills to consuming media and entertainment. E-commerce is growing, with businesses delivering more services and content across the Internet, communicating and collaborating online, and inventing new ways to connect with each other. However, presently-existing systems and methods for designing and launching a website require a user wishing to establish an online presence to navigate through a complicated series of steps to do so. First, the owner must register a domain name. The owner must then design a website, or hire a website design company to design the website. Then, the owner must purchase, configure, and implement website-related services, including storage space and record configuration on a web server, software applications to add functionality to his website, maintenance and customer service plans, and the like. This process can be complicated, time-consuming, and fraught with opportunity for user error. It may also be very expensive to produce, serve, and maintain the user's website. Merchants may be hesitant to create an online presence because of the perceived effort involved to do so. These merchants limit their business to offline “brick and mortar” points of sale.

Some existing website design approaches can simplify the design process through automation of certain of the design process steps. Typically, a user is provided a template comprising a fully or substantially hard-coded framework. The user may then customize the framework by providing content, such as media, images, descriptive text, web page titles and internal organizational links between web pages, and element layout choices. However, users that are not experienced with website design, or otherwise have little time to focus on such details, may not understand the customizable options and capabilities available to them at design time. For example, such users may not be aware that media, such as images, within a template web page may be removable, editable, or interchangeable, or that other media may be added. Further still, such a user may not be aware of how such an operation can occur or how to select and/or import media to provide a unique website.

### BRIEF DESCRIPTION OF THE DRAWINGS

FIG. 1 is a schematic diagram of a system and associated contextual operating environment in accordance with various embodiments of the present disclosure.

FIG. 2 is a functional schematic diagram of a website builder tool in accordance with the various embodiments of the present disclosure.

FIGS. 3-10 are example screenshots illustrating various aspects of the website builder tool in accordance with the various embodiments of the present disclosure.

FIG. 11 is a flow diagram of a method in accordance with the various embodiments of the present disclosure.

### DETAILED DESCRIPTION OF THE PREFERRED EMBODIMENT

The present invention overcomes the aforementioned drawbacks by providing a system and method for providing a website builder tool that includes an ability to recommend or propose media, such as, for example, images, video, or music, for inclusion in a web page created using the website builder tool. The recommended or proposed media may be determined based on multiple different factors relating to the created web page according to various embodiments. The proposed media offer users of the website builder tool the ability to quickly and easily achieve a personalized and unique look to their created web page. Further, by providing the proposed media, the website builder tool informs users who are less familiar with the website builder tool of the ability to alter, edit, or add media to the created web page. For example, a user may think media provided within a template web page are unalterable and may not otherwise attempt to edit such template media. However, by proposing media, the user is quickly informed that such a feature exists.

In one implementation, the present disclosure describes a method including providing, by a computer server, a website builder tool configured to enable a user to create a web page to be displayed on a display device. The method further includes providing a text entry user interface via the website builder tool that enables a user to input text content for web page, and receiving text content from the user via the text entry user interface. The method further includes searching an image database to identify a proposed image corresponding to at least one of the following: a keyword within the text content, a language of the text content, a genre assigned to the web page, and/or a geographical region associated with the web page. The computer server can provide an image selection user interface via the website builder tool, which enables a user to select a web page image as part of the web page via the website builder tool. The computer server can also provide the proposed image via the image selection user interface for selection by the user as the web page image.

In another embodiment, the present disclosure describes a method including providing, by a computer server, a website builder tool configured to enable a user to create a web page to be displayed on a display device and receiving text content from the user via a text entry user interface of the website builder tool. The method continues with the computer server searching one or more media databases to identify one or more proposed media corresponding to the text content. The method also includes providing the proposed media via a media selection user interface for selection by the user for incorporation into the web page.

In yet another embodiment, the present disclosure describes a system including a computer server communicatively coupled to a network and including a processor. The processor is configured to provide a website builder tool to enable a user to create a web page to be displayed on a display device and to receive text content from the user via a text entry user interface of the website builder tool. The processor is also configured to search at least one media database to identify at least one proposed media corresponding to the text content. Also, the processor is configured to provide the at least one proposed media via a media selection user interface for selection by the user for incorporation into the web page.

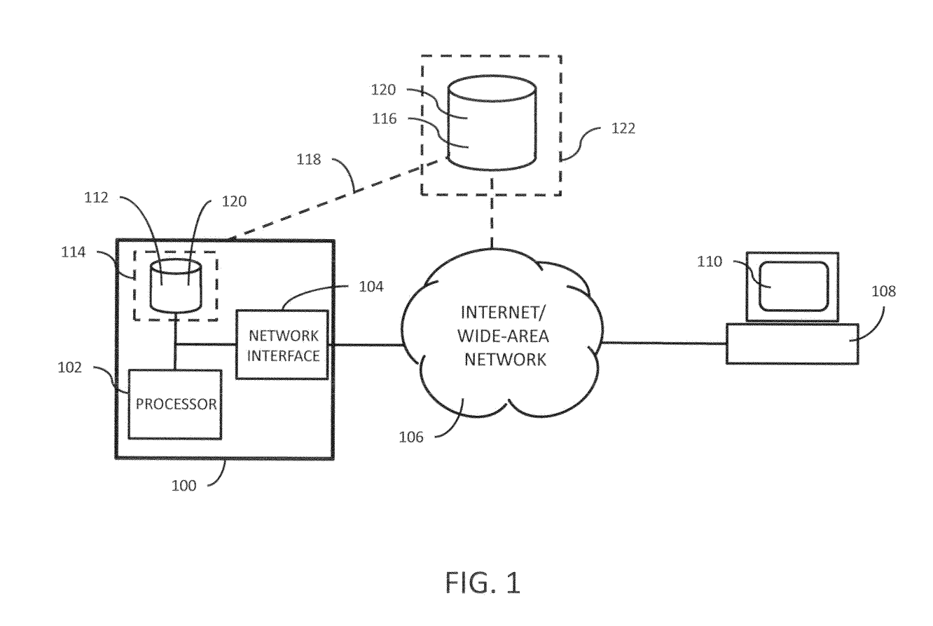

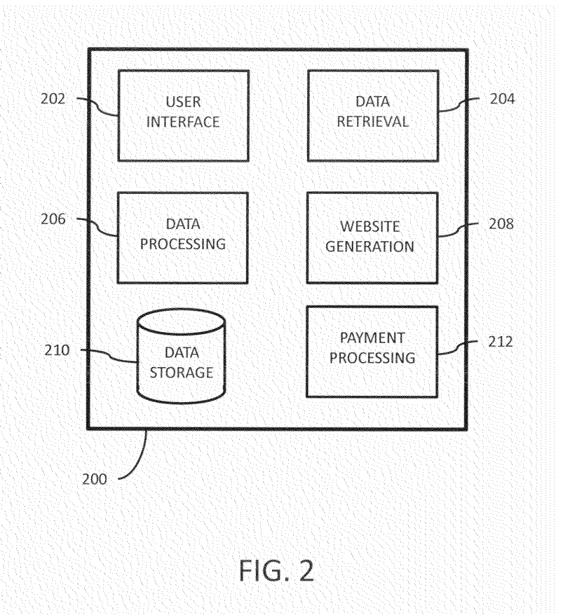

Referring first to FIG. 1, a server 100 (e.g., a server device, a network server, a web server, a computer server, or the like) may include one or more processing devices 102 (such as one or more central processors) and may include or be communicatively coupled to a network interface 104. The network interface 104 may in turn be communicatively coupled to a wide-area network such as the Internet 106. The server 100 may be one of many servers 100, for example, as part of a server farm configured to service a large number of client devices 108. A plurality of servers 100 may be communicatively coupled together through a network with other control computers configured to control aspects of the servers 100 and to route communications to and from the servers 100. In one embodiment, the server 100 is configured to communicatively couple to a client device 108 through the network interface 104 and the Internet 106 to provide a website builder tool 200 (see FIG. 2) to the client device 108. Communications between the server 100 and the client device 108 may be achieved using any electronic communication medium, communication protocol, and computer software suitable for transmission of data over the Internet 106. Examples include, respectively and without limitation: a wired connection, WiFi or other wireless network, cellular network, or satellite network; Transmission Control Protocol and Internet Protocol (“TCP/IP”), Global System for mobile Communications (“GSM”) protocols, code division multiple access (“CDMA”) protocols, and Long Term Evolution (“LTE”) mobile phone protocols; web browsers such as MICROSOFT INTERNET EXPLORER, MOZILLA FIREFOX, and APPLE SAFARI; and other client-executable software modules.

The client device 108 may comprise various computing devices such as, for example, a desktop computer, a laptop computer, a tablet, a smart phone, other network servers, or any other electronic device capable of communicating with the server 100 over the Internet 106. Such a client device 108 may include one or more processing devices, display devices 110, user interfaces, and/or network interfaces. Typically, though not always, the client device 108 is utilized by a user to access the server 100 or a service provided by the server 100. In various embodiments, a user utilizes the client device 108 to access a website builder tool provided by the server 100 via the Internet 106. The user may be an individual, a group of individuals, a business or other organization, or any other entity that desires to build a website and use it to convey information about itself or another topic, where the information may be of a commercial or a non-commercial nature. For clarity of explanation, and not to limit the implementation of the present methods and devices, the methods are described herein as being performed by a server 100 that receives input for creating a website for a small business, such as a restaurant or bar, retail store, or service provider (i.e. barber shop, real estate or insurance agency, repair shop, equipment renter, plumber, and the like), unless otherwise indicated. However, such methods are equally applicable to the creation of websites devoted to other business and non-business related websites.

The server 100 may include or be configured to communicate electronically with one or more data stores 112 in order to retrieve information from the data store 112. In some embodiments, a data store 112 may be a component of the server 100, such as, for example, a memory device 114 of the server 100 or communicatively coupled to the server 100 (such as a memory module or a disk drive). In other embodiments, a data store 116 may be part of a different server 100, or as part of a network-accessible data store 116. Electronic communication with the data store 116 may be achieved over the Internet 106 using any suitable electronic communication medium, communication protocol, and computer software including, without limitation: a wired connection, WiFi or other wireless network, cellular network, or satellite network; TCP/IP or another open or encrypted protocol; browser software, application programming interfaces, middleware, or dedicated software programs. Electronic communication with the data store 116 may be achieved over another type of network 118, such as an intranet or virtual private network, or may be via direct wired communication interfaces or any other suitable interface for transmitting data electronically from a data store 116 to the web server 100. A data store 116 may be any repository of information that is or can be made freely or securely accessible by the web server 100.

Suitable data stores 112, 116 include, without limitation: databases or database systems, which may be a local database, online database, desktop database, server-side database, relational database, hierarchical database, network database, object database, object-relational database, associative database, concept-oriented database, entity-attribute-value database, multi-dimensional database, semi-structured database, star schema database, XML database, file, collection of files, spreadsheet, or other means of data storage located on a computer, client, server, or any other storage device known in the art or developed in the future; file systems; and electronic files such as web pages, spreadsheets, and documents. In particular embodiments, the data stores 112, 116 comprise, individually or together, at least in part, a media database 120 (for example, an image database). Each data store 112, 116 accessible by the web server 100 may contain information that is relevant to the creation of the website, as described below. Such data stores include, without limitation to the illustrated examples: search engines; website information databases, such as domain registries, hosting service provider databases, website customer databases, and internet aggregation databases such as archive.org; government records databases, such as business entity registries maintained by a Secretary of State or corporation commission; public data aggregators, such as FACTUAL, ZABASEARCH, genealogical databases, and the like; social networking data stores, such as public, semi-private, or private information from FACEBOOK, TWITTER, FOURSQUARE, LINKEDIN, and the like; business listing data stores, such as YELP!, Yellow Pages, GOOGLE PLACES, LOCU, and the like; media-specific data stores, such as art museum databases, library databases, and the like; point-of-sale transaction data stores; and offline crawling data stores.

Each of the various databases described herein may, at least in part, include or make up databases configured to store media files, such as, for example, images, video, audio, animations, or other media that may or may not be suitable for use in or on a website. In the present example the media database 120 includes an image database configured to store one or more images, though it should be understood that media database 120 may be configured to store any media. In the example image database, images may exist in various formats, including but not limited to jpeg files (JPG), bitmap files (BMP), TIFF files (TIF), RAW files, PNG files, GIF files, Exif files, and other image file types. Other media types that may exist in a media database 120 may include audio files such as WAV files, MP3 files, AIC files, AIFF files, FLAC files, M4A files, OGG files, TTA files, WMA files, or other audio file types. Other media types that may exist in a media database 120 may include video or animation (e.g., flash) files such as AVI files, SWF files, MPEG files, MOV files, RM files, WMV files ASF files, 3GP files, AAF files, FLV files, FLA files, SOL files, and other video or animation file types.

Media files may include metadata or other data associated therewith or may otherwise be cataloged, tagged, and/or described so as to be searchable and/or managed. By certain embodiments, a data store 116 may include one or more media databases 120, such as an image database, provided by an online service 122 other than the website builder tool 200 provided by the server 100. The third-party online service 122 may include various media storage services, media providing services, social networking services, or other cloud storage services. Such examples of third-party online services 122 that may include such media databases 120 include, but are not limited to, FOTOLIA, GOOGLE, YAHOO, PICASA, FACEBOOK, INSTAGRAM, MYSPACE, FLICKR, DROPBOX, BARRACUDA, SMUGMUG, PHOTOBUCKET, SHUTTERFLY, SNAPFISH, AMAZON, APPLE ICLOUD, BOX, GOOGLE+, GOOGLE DRIVE, IDRIVE, MICROSOFT ONEDRIVE, SAFESYNC, MEGA, MEDIAFIRE, ISTOCKPHOTO, FREEIMAGES, SHUTTERSTOCK, OPENPHOTO, MORGUEFILE, GETTYIMAGES, DREAMSTIME, VEER, CORBISIMAGES, ASSOCIATED PRESS, LIBRARY OF CONGRESS, NATIONAL GEOGRAPHIC, and the like. The third-party online services 122 may include media databases 120 that are free to use, require a fee to use, require various licensing agreements (for fee or free), or are public domain. The media database 120 may be curated or managed by the third-party online service 122 (e.g., GETTY IMAGES) or by, at least in part, the user of the client device 108 (e.g., FACEBOOK, FLICKR, or PICASA web albums or other users).

In one embodiment, the server 100 communicates with the client device 108 through the Internet 106 to provide a website builder tool 200 to the client device 108 that enables a user of the client device 108 to create or design a web page that can be displayed on a display device 110 as part of a website. The display device may be the display device 110 of the client device 108, or more typically, a display device 110 of a different computer device that may be used by a different user to discover or seek the web page or website while on the Internet 106. In the present disclosure, the term website or web page refers to any public, private, or semi-private web property on which a user may maintain information and allow the information to be presented to the public or to a limited audience, and which is communicable via the Internet 106. Non-limiting examples of such web properties include websites, mobile websites, web pages within a larger website (e.g. profile pages on a social networking website), vertical information portals, distributed applications, and other organized data sources accessible by any device that may request data from a storage device (e.g., a client device in a client-server architecture), via a wired or wireless network connection, including, but not limited to, a desktop computer, mobile computer, telephone, or other wireless mobile device; content feeds and streams including RSS feeds, blogs and vlogs, YOUTUBE channels and other video streaming services, and the like; and downloadable digital platforms, such as electronic newsletters, blast emails, PDFs and other documents, programs, and the like.

Turning now to FIG. 2, according to various embodiments, the website builder tool 200, as may be provided by the server 100, provides an interface to a user, via the client device 108, to facilitate initial generation, creation, or design of the user's web pages or websites as well as updates or edits of the same. The website builder tool 200 may include a plurality of modules, each configured to perform or enable various tasks. The modules may be hardware or software-based processing modules located within the server 100, in close physical vicinity to the server 100, or remote from the server 100 and implemented as standalone server computers or as components of one or more additional servers or of one or more other computing devices. The modules of the website builder tool 200 may include, without limitation: a user interface module 202 for providing input/output capabilities between the website builder tool 200 and the user; a data retrieval module 204 for performing searches of data stores 112, 116; a data processing module 206 for evaluating retrieved data, comparing retrieved data to other data, and the like; a website generation module 208, which may be a component of the data processing module 206 or a separate module, and which creates web pages and posts new content thereto; one or more data storage modules 210 for storing the data retrieved by the data retrieval module 204, content objects created by the data processing module 206, and the website generated by the website generation module 208; and a payment processing module 212 for processing payment information provided when a user chooses to purchase a generated website, generated or utilized content, or other elements of data generated or utilized via the methods described herein.

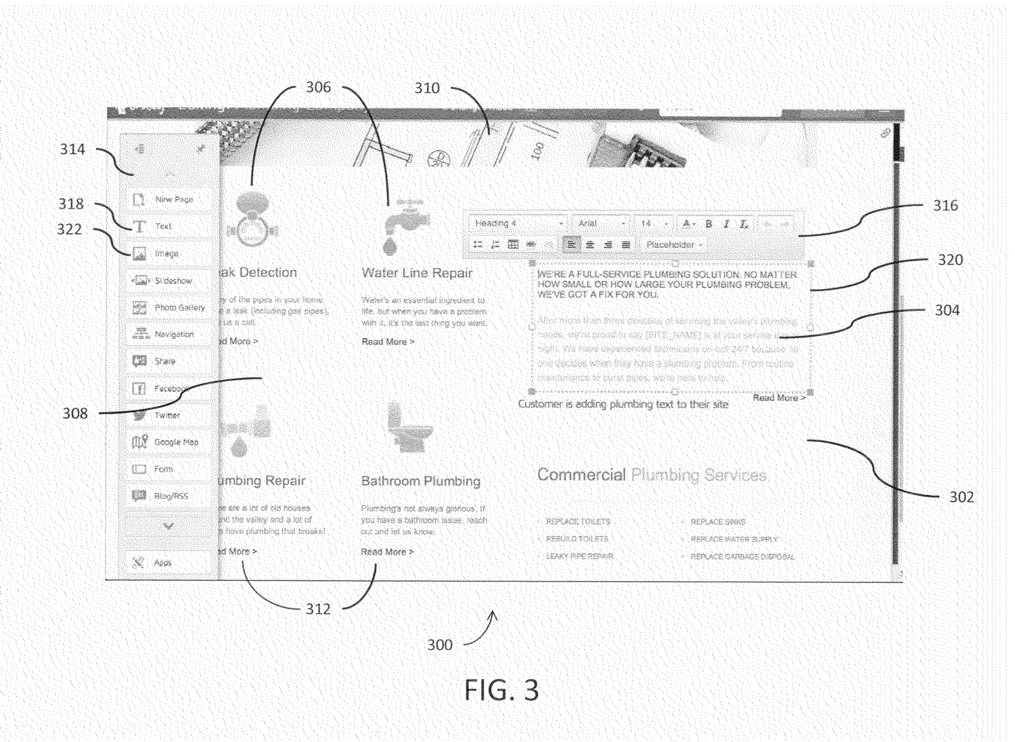

The website builder tool 200 may be any suitable website building application that may be configured to perform or to be compatible with the methods described herein. In one embodiment, the website builder tool 200 is the GODADDY Website Builder. The website builder tool 200 provides a layout tool for what-you-see-is-what-you-get web page building, in which the user may drag, drop, resize, change properties, and otherwise edit web page elements in an environment that reflects what the web page may actually look like when it is published. For example, and turning now to FIG. 3, an example screenshot 300 of a website builder tool 200 is shown in accordance with various embodiments. The web page 302 being designed in this example is for a plumbing service and includes plumbing-related media (for example, images of a toilet, a water spigot, construction plumbing blue-prints, and the like). The website builder tool 200 allows a user to generate, create, design, modify, edit, alter, or update the shown web page 302. For example, a user may add, remove, move, or edit text 304, media 306, backgrounds 308, or other web page elements (for example, headers 310, links 312, etc.). A user can add, remove, or otherwise alter links 312 to other internal or external web pages or documents to manage the overall structure of the website. Many other features may also be included with the website builder tool 200 that are directly or indirectly pertinent to the creation of the web page 302 or the entire website, which features are generally understood in the art and are fully contemplated by this disclosure.

In one embodiment, the website builder tool 200, and thus the server 100, may provide to the user or communicate to the client device 108 a template web page. A user may select a template web page, which can be edited or altered by the user via the website builder tool 200 to create the web page 302. The template web page may include various text 304, media 306, backgrounds 308, and the like within a particular layout structure. The website builder tool 200 may enable a user to alter, remove, or replace these elements. The user may select a template web page based on many factors, including a theme genre or a general visual preference. Theme genres can range from broad theme genres (e.g., service providers, product manufactures, sports teams, restaurants, etc.) to more specific theme genres (e.g., plumbing, architecture, law, electronics manufacturing, software design, baseball teams, fine dining, etc).

In one embodiment, the website builder tool 200 may provide a user interface that includes one or more tool or option panels 314 (as shown aligned on the left side of the screen) that are selectable and usable by a user. One such tool may be a text entry user interface 316, which may be initiated or provided by selecting the “Text” button 318 on the panel 314 or by clicking other text fields within the web page 302. The text entry user interface 316 may provide a user with a movable and re-sizable box 320 in which to place text 304 and options to alter the appearance of that text 304 (for example, font, size, style, etc.). For example, by other approaches, the text entry user interface 316 may allow selection and uploading of other text 304 located within other files that may be on the client device 108 or elsewhere. Further, other modifications are possible to achieve entry of text content 304 for the web page and 302 are contemplated herein. The server 100 via the website builder tool 200 receives the text content 304 from the user of the client device 108 via the text entry user interface 316.

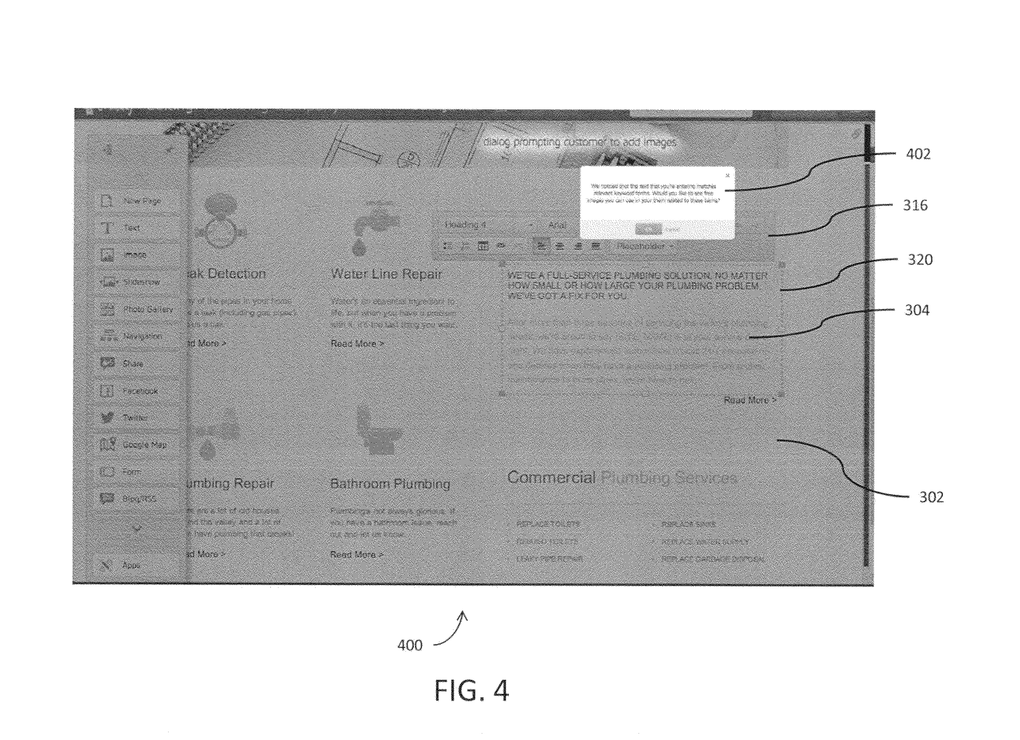

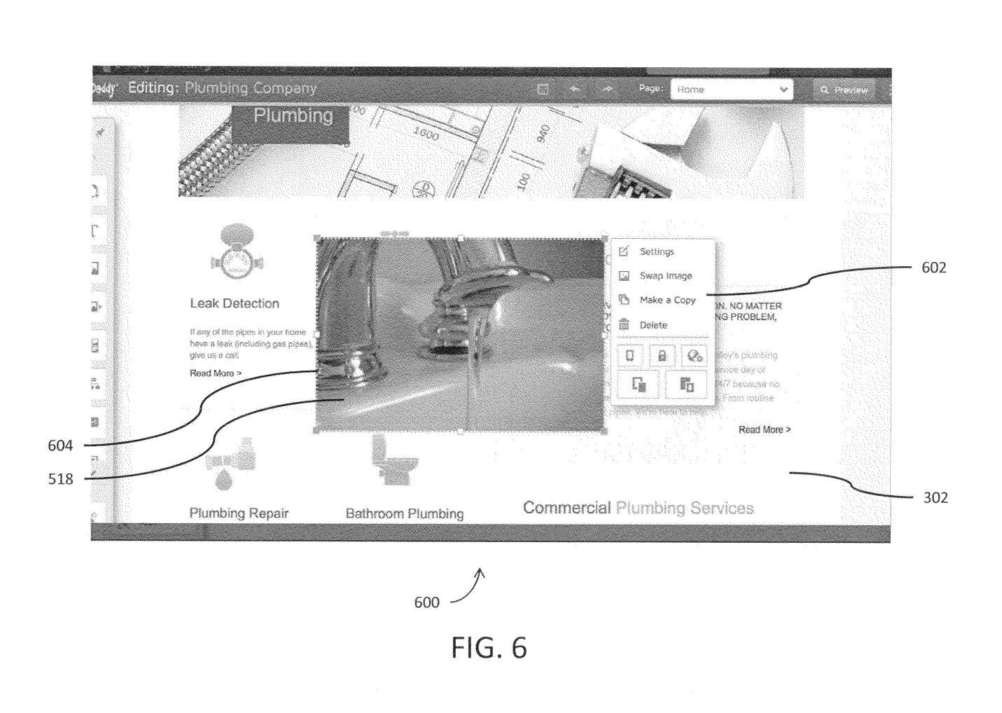

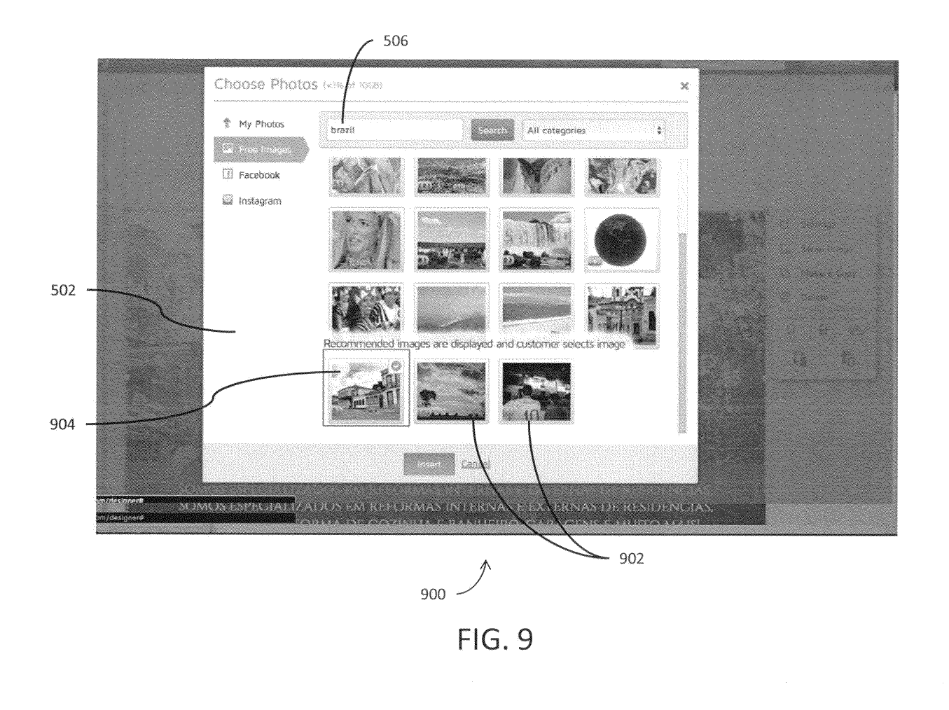

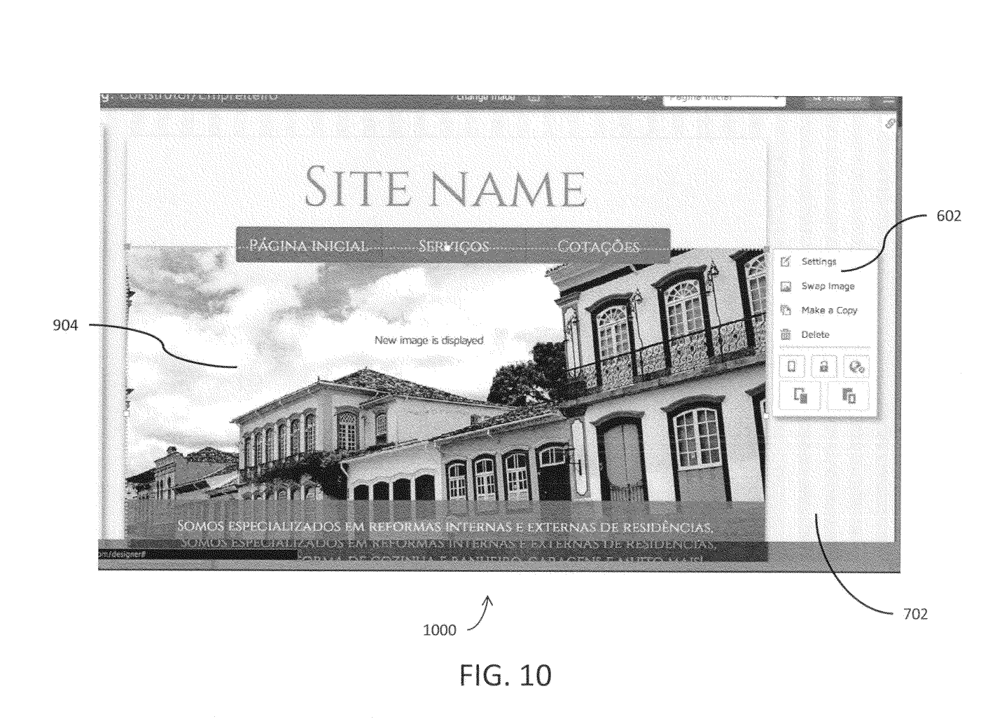

Similarly, the website builder tool 200 may provide other tools such as a media selection user interface 502 (see FIGS. 4 and 9) and a media editing user interface 602 (see FIGS. 6 and 10), which allow a user to select and edit, respectively, web page media 306 (for example, an image) as part of the web page 302. These media-related user interfaces 502, 602 may be accessible by clicking on one or more items of media 306 (e.g., images), by pressing a media-related button 322 (for example, an “Image” button) within the tool panel 314, or by other methods.

Often, a user of the website builder tool 200 may be inexperienced with website or web page creation. As such, a user may be unaware that the user can add, remove, replace, edit, or alter media 306 within a web page 302. For example, if the user selects a template web page to use in the creation of their own web page 302, the user may not understand that the user can add or edit the media within the template web page while, for example, utilizing the same layout provided with the template web page. Accordingly, it is one purpose of various disclosed embodiments to provide a user with a clear indication that such modifications are possible and to provide the user with an easy route to do so. Further, to facilitate the selection and incorporation of new media content, to the present system is configured to provide a user with suggested or proposed media (for example, images) based on various aspects of their web page 302.

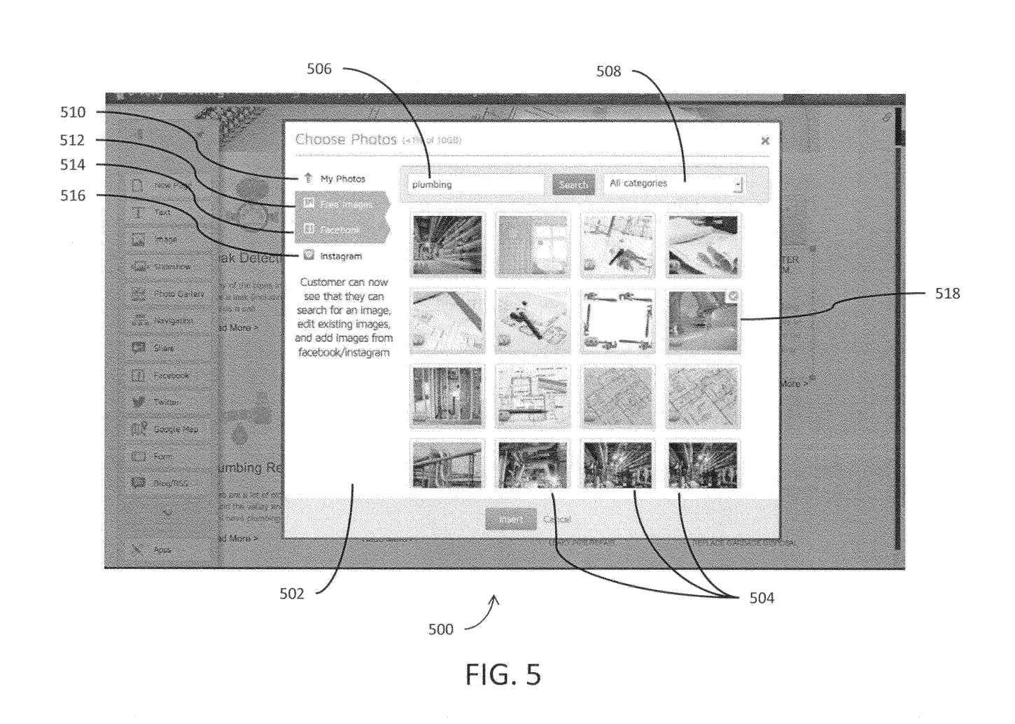

According to various embodiments, the server 100, in providing the website builder tool 200, may be configured to search at least one media database 120 to identify one or more items of proposed media. The proposed media are then provided to the user via a media selection user interface 502 (see FIGS. 5 and 9) for selection by the user as web page media (e.g., an image for use on the web page 302, such as media 306). The server 100 may conduct the search of the media databases 120 to find media that correspond to various aspects of the web page 302, which are described below. Thus, the proposed media may be directly pertinent to the web page, allowing the user to quickly find and select an appropriate media for inclusion in the web page. Further, the server 100, in providing the website builder tool 200, can provide proposed media at various times during the web page development process so that a user is informed or reminded of the ability to customize the web page 302 by adding, removing, or altering media. Further still, by providing the proposed media throughout the design process, the user can be directed to make suggested customizations that the user may not otherwise make. For example, the user may become aware of the ability to generally alter media after a first indication is presented during the design process. However, the user may not be aware of every particular item of media (e.g., image) that can be changed or of the ability to add different media in different locations. Further, the user may not think, from a design standpoint, to add media pertaining to various other aspects of the web page 302, for example, a certain portion of text content 304 that the user entered. Thus, the user can be come aware of the ability to alter the media, such as the images, and can be provided with proposed media which may in turn be the catalyst to making even further customizations.

Returning now to FIG. 3, in one embodiment, the server 100, via the website builder tool 200, may search to identify proposed media corresponding to one or more contextual keywords within text content 304 input by the user for the web page 302. Searching may be performed at various points during the design process. In one approach, a search may be performed in real-time as a user enters text 304. In another approach, a search may be conducted after editing of a given block or portion of text 304 is completed (for example, after exiting or closing the text entry user interface 316 for a given text block 320 or after selecting a different text block to add or edit). In still another approach, a search may be conducted after completion of a web page design or when a design is actively saved. In another approach, a search may be conducted periodically with regular or semi-regular frequency.

Referring now to FIG. 4, a screenshot 400 of the website builder tool 200 is provided in accordance with one embodiment. As is shown here, a pop-up prompt 402 is provided within the website builder tool 200, possibly effected by the server 100. The pop-up prompt 402 may be communicated to the client device 108 from the server 100 and may indicate to the user that the text 304 being entered matches relevant keyword terms relating to various media. The pop-up prompt 402 may then ask the user if the user would like to see proposed media that are related to the keywords. A user can then press “OK” and be directed to a media selection user interface 502 (see FIGS. 5 and 9) to select related proposed media. In one embodiment, a search step is not performed until a user indicates their desire to see proposed media. The pop-up prompt 402 may be presented at any point during the design process as was described with respect to the search above and may be a gateway step before conducting the search. In one embodiment, in order to maintain a chronologically proximate relationship with the pertinent text entry, the pop-up prompt 402 may be provided while entering text 304 using the text entry user interface 316 or upon completion of editing or entering text 304 of a particular text box 320. For example, the server 100 may communicate the pop-up prompt 402 in response to receiving the text 304. In order to further this proximate relationship with the text 304, in one embodiment, the pop-up prompt 402 is provided near the portion of text that is being or was just edited on the display 110. A user may select “OK” within the pop-up box and be directed to a media selection user interface 502, as is shown in FIG. 5.

In one embodiment, a scan is performed on the text 304 to determine the presence of at least one keyword. The keyword may be one of a plurality of keywords that the website builder tool 200 looks for in text content 304, which keywords may relate to any topic. In the example text 304 shown in FIG. 3, a keyword may by “plumbing,” and a scan of the entered text 304 would indicate the presence of this keyword in the text 304. Multiple keywords may be discovered in text 304. As a result, multiple keywords may be searched, or the keywords may be ranked internally according to various aspects, such as frequency or location within the text 304 (e.g., keywords that appear more often or near the top may be more important that other keywords). Also, multiple keywords may be ranked or filtered according to a relative specificity or relative determined importance. For example, two keywords, “plumbing” and “service,” may be detected in a scan of the text. However, the website builder tool 200 may determine that the term “plumbing” is more specific than “service” and will likely yield more pertinent media. In other approaches, the designers of the website builder tool 200 may have determined that a keyword such as “plumbing” is to be ranked higher than a keyword such as “service.” Many different schemas exist as to ranking of keywords within text 304 and are contemplated by this disclosure.

Turning now to FIG. 5, a screenshot 500 is provided showing a media selection user interface 502. The media selection user interface 502 enables a user to select at least one item of media to be included as web page media as part of the web page 302. The media selection user interface 502 provides a plurality of proposed media 504 available to the user (such as, for example, proposed images), which proposed media 504 are communicated from the server 100 to the client device 108. The proposed media 504 may be communicated in whole or in part (e.g., as thumbnails). Also, in various embodiments, a keyword input portion 506 is presented. The keyword input portion 506 may be auto-populated with the selected keywords from the text 304, being “plumbing” in this contextual example. A category selection portion 508 (e.g., drop down menu) may also be provided to allow a user to narrow a search to a particular category. For example, the user may want to limit the proposed media to photographs, illustrations, or graphics, or may only be looking for background images, header images, or other web page specific images or media. Various categories may be utilized to categorically distinguish sets of media to allow the user to further limit the scope or specify what they are searching for.

In certain embodiments, a user can specify various available media databases 120 to be searched or excluded from a search. For example, as is shown in FIG. 5, various tabs corresponding to various media databases 120 may be activated or deactivated in accordance with the user's desires or other criteria. One media database 120 may be a media database 510 that may contain media such as photos or videos which the user has uploaded to the server 100 and stored within data store 112 or 120 or uploaded to another related server (shown here as “My Photos” database). The media selection user interface 502 may show a usage amount of an available data storage amount (e.g., “1% of 10 GB”). By other approaches, the “My Photos” media database 510 may be stored at a data store 120 of a third-party online service provider 122 other than the website builder tool 200 (e.g., DROPBOX, FLICKR, FOTOLIA, etc.). These media may be the user's own photographs, graphics, videos, sounds, or other media, or may be other purchased or free media which the user may have procured from various sources, including the Internet 106. Another media database 120 may be a free media database 512 (shown here as a “Free Images” database) that may include media that are made available to the user free of charge. These may be one or a collection of media databases that provide free public-domain or free limited-license media for use by the general public or by a user of the website builder tool 200. In some approaches, this free media would not otherwise be free to the user if not for the relationship with the website builder tool 200. For example, the provider of the website builder tool 200 (e.g., GO DADDY) may put in place an agreement with a media provider service to be able to provide media to users for free (or, for a discount, in certain approaches) where use of such media that would otherwise incur a fee outside of the website builder tool 200 environment.

In various embodiments, the provider of the website builder tool 200 may provide either or both free and for-fee items of media (e.g., photos or images) to users. For example, for-fee media may be provided as a “premium” option available to the user. Free and for-fee items of media may appear simultaneously within a media selection user interface 502, possibly encouraging the selection of such premium content, or in separately delineated or filtered views (e.g., by selecting an option to show only free media, or a tab showing only premium images). For-fee media may be designated as such with an emblem or other indication, such as, for example, a dollar sign or a star. This designation indicates that the use of the specified items of media will incur additional fees, are available as part of a premium account, or both. Various items of media may be designated as for-fee or “premium” by either the provider of the website builder tool 200 or third-party media providers (e.g., FOTOLIA).

In other embodiments, another media database 120 may be a different media database such as a FACEBOOK media database 514 or an INSTAGRAM media database 516. These media databases 514, 516 are typically curated and managed by the user. A user may, in a separate step, allow the website builder tool 200 access to their accounts associated with these services to allow the website builder tool 200 to access the respective media databases 514, 516. Other social network or online media repository services may searchable as well (for example, MYSPACE, FOURSQUARE, SNAPCHAT, FLICKR, PICASA, IDRIVE, etc.).

The server 100, via the website builder tool 200, may search the one or more media databases 120 seeking media that is related to the keyword. For example, this may involve performing a query (for example, a query using the particular keyword) for media that are associated with the keyword. Such associations may be made with descriptions, tags, or categories linked to the media within the media databases 120 or other metadata related to the media. In some embodiments, a search can be conducted based on aspects of the media, including appearance, color, patterns, density, brightness, focus, contrast, exposure, aperture, focal length, dynamic range, mood, theme, composition, orientation, sound, format, function, landscapes, objects, people (or omission of people), length (e.g., for movies or other animations), volume, file size, author or creator, dimensions, location, country or region, geotag, events (e.g., a wedding, a birthday, a day at a beach, a storm, etc.), time or period-setting, popularity, originating format (e.g., scanned from Polaroid picture, converted from VHS video), camera type (DSLR, camera-phone, etc.), originating platform (e.g., Mac, PC, etc.), software (Photoshop, Moviemaker, etc.), effects (e.g., vignette, lens flair, etc.), or any other known or suitable aspects relating to media. In other approaches, the search may be performed by seeking media that is similar in appearance, color, mood, composition, sound, format, or function (or any other aspect) to other known media that relate to a keyword or to an aspect of that known media. For example, a user may like the appearance of an image of a plumber's wrench, but wants to find an image with similar characteristics that shows a faucet also. In still other approaches, the search may be performed by seeking media that are used in a similar context (e.g., images used on other plumbing-related websites). These various searches may be performed by the data retrieval module 204 of the website builder tool 200 in one embodiment.

Continuing with FIG. 5, a user can select 518 one or more items of media (shown here as images with a check mark) to be used as web page media in the web page 302. Upon selection 518, the server 100 may receive from the client device 108 via the website builder tool 200 the selection of the proposed media as web page media for use as part of the web page 302. The user may subsequently be provided with a media editing user interface 602 that allows the user to edit and place the selected proposed media 518 within the web page 302. FIG. 6 shows a screenshot 600 of the website builder tool 200 showing the media editing user interface 602 in accordance with various embodiments. The media editing user interface 602 may include one or more image-related editing tools (e.g., crop, re-size, etc) or other media-related editing tools, as well as a media boundary box 604 to allow the user to edit the size and placement of the selected proposed media 518 within the web page 302. Many other media editing capabilities not described here may be provide with the media editing user interface 602 which are generally understood in the art and are fully contemplated by this disclosure. With this feature, a user can edit their web page or a template web page 302 by adding a proposed item of media to their web page (or the template web page) or replacing media (such as a template web page image) with the proposed media.

In another embodiment, the server 100, via the website builder tool 200, may search for proposed media based on the theme genre assigned to the web page 302. Continuing with the previous example, a user may have indicated, and the server 100 may receive such indication, that the web page is a “services” web page, or more specifically, a “plumbing” web page. Such an indication may be made via various menus or may be input at the beginning of or during the design process while using the website builder tool 200. Further, a theme genre may be indicated by making a selection of a template web page that is related to that theme genre. For example, the user may have searched for a “plumbing” web page template and selected one the user thought appropriate, thereby establishing a “plumbing” theme genre.

With the knowledge of the theme genre assigned to the web page 302, the server 100, via the website builder tool 200, can search a media database 120 to identify proposed media corresponding to the theme genre of the web page 302. For example, and returning to FIG. 5, the media selection user interface 502 may be provided showing proposed media 504 relating to “plumbing.” As with the text keyword-based searching described above, the user may make a selection of selected proposed media 518 for inclusion in the web page 302, and the website builder tool 200 may provide a pop-up prompt (such as pop-up prompt 402) informing the user of the ability to view proposed media relating to the theme genre and to select one or more proposed media 504 for inclusion in the web page 302.

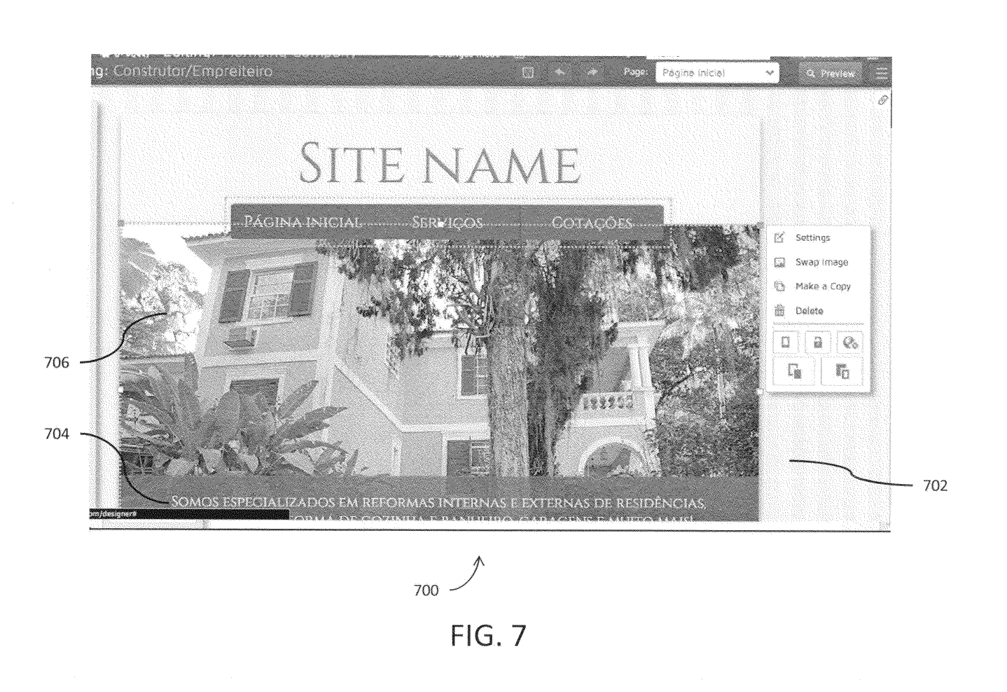

Turning now to FIG. 7, a screenshot 700 illustrates another feature of the of the website builder tool 200 in accordance with various embodiments. In this example, the web page 702 being designed with the website builder tool 200 contains text 704 in a non-English language (Portuguese, as is shown in this example), which the website builder tool 200 recognizes as such. The text 704 may be entered by methods described herein or by other methods. The web page 702 may also include one or more items of media 706, such as one or more images.

According to one embodiment, the server 100, via the website builder tool 200, may determine a geographical region associated with the web page 702 by, at least in part, determining a geographical region associated with the language of the text 704. For example, the server 100 may determine the web page 702 is associated with Brazil due to the presence of Portuguese text 704. The server 100 may take into account particular dialects or other factors in making such a determination or may provide an option for a user to select a correct geographical region from a plurality of candidate geographical regions (e.g., a user can select Brazil from a list of Portuguese speaking countries). In other embodiments, the server 100 may use any other appropriate data for associating the web page 702 with a particular location or geographical region. For example, a geographical region may be selected based upon the location of the user (e.g., as determined by a geolocation lookup performed on the IP address of the user), the location of a majority of visitors to the web page 70 (e.g., as determined by a geolocation lookup performed on the IP address of the web page's visitors), information associated with the business of the user, such as the business' postal address or the address of one or more customers of the business, which may be determined, for example, by analyzing the shipping history of past orders made to the business.

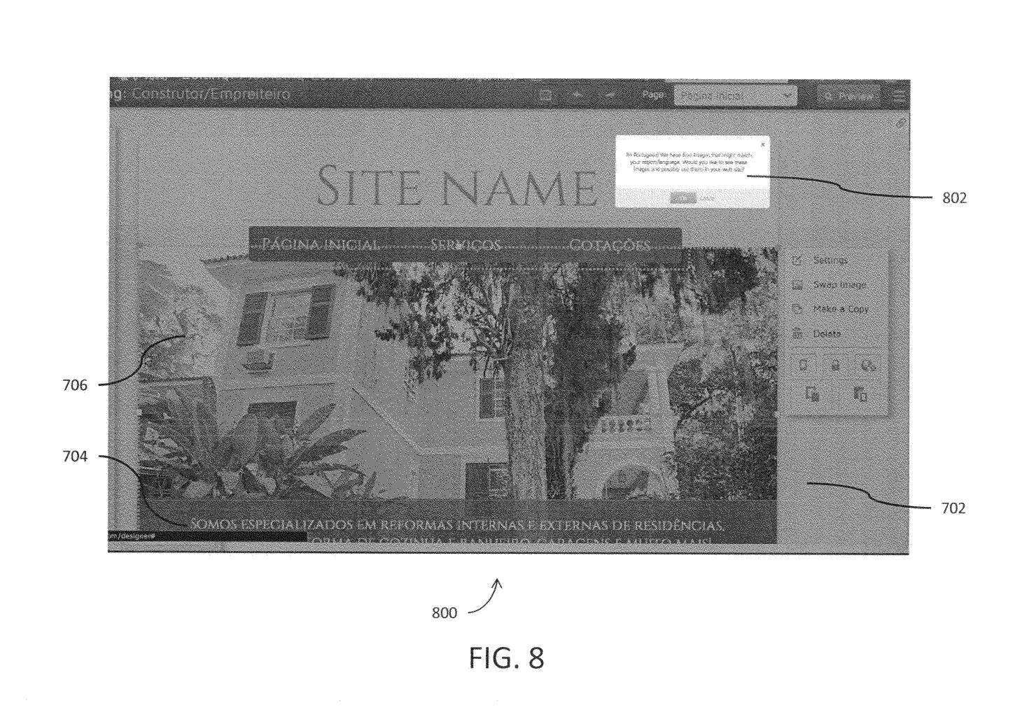

Turning to FIG. 8, in one embodiment, the website builder tool 200 may provide a pop-up prompt 802 indicating to the user the availability of media relating to the language of the text 704 being entered and/or the geographic region associated with the web page 702. The pop-up prompt 802 may be provided in the detected language. The pop-up prompt 802 may then ask the user if the user would like to see proposed media that are related to the language or the associated geographical region. In one embodiment, a media search step is not performed until a user indicates their desire to see proposed media. The pop-up prompt 802 may be presented at any point during the design process. In one embodiment, the pop-up prompt 802 may be provided upon entry of text 704 in the foreign language, or may be provided upon selection of one or more items of media 706 for editing, such as one or more images. Other events may trigger the occurrence of the pop-up prompt 802, as well. In certain embodiments, search terms that are associated with a theme or template provided for that region and/or language can be can be pre-loaded into a keyword search field according to the language or geographical region associated with the web page 702. For example, a German plumbing website theme template could have the word “klempner” (German for “plumber”) pre-loaded into the search field to initiate a search based on the language and/or geographical region. In one approach, pre-loading can be performed by associating a keyword with a parent theme (e.g., a plumbing website) and then translating the keyword in accordance with a child theme (e.g., a plumbing website in German).

In an alternative embodiment, a user may indicate or specify a particular geographical region or location associated with the web page 702. For example, the user may indicate that this web page 702 is to be specifically targeted toward Brazil (e.g., the web page 702 is for people located in Brazil) or is specifically related to Brazil (e.g., an American travel company dealing with travel destinations in Brazil). Such an indication may be made via various menus or may be input at the beginning of or during the design process while using the website builder tool 200. Further, in another embodiment, the website builder tool 200 may determine a geographical location associated with the web page 702 by various addresses or other references provided in the web page that would indicate the relationship to that geographical region (e.g., the presences of a Brazilian address or phone number).

Various items of media may be associated or related to a language or a geographic region. For example, one or more databases may map the items of media to one or more particular languages and/or regions. Such a database could be created or maintained manually by one or more users and/or could be created or maintained through one or more automated processes. For example, a computing device could scan an image for the presence of writing in a certain language, or scan audio for spoken words in a certain language, which in turn can be used to associate the image with that language or a region that speaks that language. A computing device may also scan images or audio for visual or auditory artifacts that are indicative of certain languages, cultures, or regions. For example, a computing device may detect the presence of a French flag or the Eiffel Tower within an image or video, which may indicate the item of media's association with the French language or the country of France. In another example, the computing device may detect in audio the Mexican National Anthem (“Himno Nacional Mexicano”) being played or sung within an item of media, which may indicate the item of media's association with the Spanish language or the country of Mexico. Many other variations are possible with respect to the detection of content within media. In another example, a computing device may review file names or metadata associated with an item of media to see where it was created or captured or to review the actual language of the metadata, which in turn can be used to associate the item of media with one or more languages and/or regions.

Turning now to FIG. 9, a screenshot 900 of a media selection user interface 502 is provided as was described above. In one approach, a keyword input portion 506 may be completed with various terms relating to either the language or the geographical location. As is shown in FIG. 9, the term “Brazil” is searched to return a plurality of proposed media 902 relating to “Brazil.” In a language-based search, a keyword might be “Portuguese”, or a search might be conducted looking for media with comments, tags, or metadata relating to or written in Portuguese. Other methods of determining proposed media based on language and/or geographical region are possible and are contemplated by this disclosure. A user may then select a proposed item of media 904 for inclusion in the web page 702. FIG. 10 is a screenshot 1000 of the web page 702 with the selected proposed media 904, which can be altered with the media editing user interface 602, as described above.

It should be understood that, according to various embodiments, various ones of the above described media searches can be performed with various ones of the above described search criteria. For example, the server 100 can search for proposed media based on one or more of the following, alone or in combination: (1) a keyword within the text content input by the user for the web page; (2) a language of the text content; (3) a theme or genre assigned to the web page; and (4) a geographical region associated with the web page. Other search criteria may be used in combination with the above criteria. Further, the server 100 may be configured to perform searches including different permutations of one or more of these criteria according to the various needs of a particular website building tool 200 session.

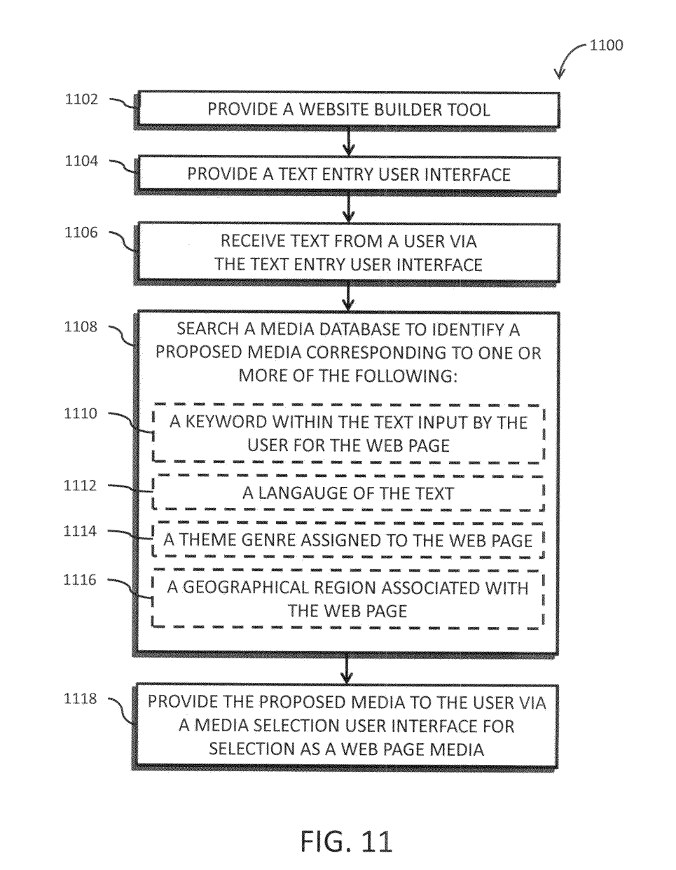

Turning now to FIG. 11, an example method 1100, for use with the described server 100 is illustrated in accordance with various embodiments. At step 1102, a server 100 provides or communicates a website builder tool 200 to a client device 108. At step 1104, the server 100 provides a text entry user interface 316 to enable a user to input text contents 304, 704 for the web pages 302, 702. At step 1106, the server 100 receives text 304, 704 from a user via the text entry user interface 316. At step 1108, the server 100 initiates a search of one or more media databases 120 to identify one or more proposed items (e.g., images) of media 504, 902. The proposed media 504, 902 may correspond to one or more of the following: A keyword within the text 304, 704 input by the user for the web page 302, 702, as is shown at 1110; A language of the text 304, 704, as is shown at 1112; A theme or genre assigned to the web page 302, 702, as is shown at 1114; or a geographical region associated with the web page 302, 702, as is shown at 1116. At step 1118, the server 100 may provide the proposed media 504, 902 to the user via a media selection user interface 502 for selection as web page media for use in the web page 302, 702.

The media search may be performed to seek proposed media 504, 902 relating to any of the options 1110, 1112, 1114, and 1116, which may be individually utilized or combined with other options thereof. For example, if a media search is conducted for proposed media corresponding to a keyword within the text input (1110), the same search (or another search) may also be conducted so that the proposed media also corresponds to one or more of the other options (1112, 1114, 1116). In another example, if a media search is conducted for proposed media corresponding to a language of the text (1112), the same search (or another search) may also be conducted so that the proposed media also correspond to one or more of the other options (1110, 1114, 1116). In yet another example, if a media search is conducted for proposed media corresponding to a theme or genre assigned to the webpage (1114), the same search (or another search) may also be conducted so that the proposed media also correspond to one or more of the other options (1110, 1112, 1116). In yet another example, if a media search is conducted for proposed media corresponding to a geographical region associated with the web page (1116), the same search (or another search) may also be conducted so that the proposed media also correspond to one or more of the other options (1110, 1112, 1114). The media searches for the proposed media may also be related to other aspects not specifically discussed herein.

So configured, the server 100, in providing the website builder tool 200, can provide proposed media that may be directly pertinent to the designed web page to more efficiently allow a user to incorporate media into the web page. Further, a user is informed or reminded of the available ability to customize the web page by adding, removing, or altering media, and is directed to make suggested customizations that the user may not otherwise make. This may ultimately be a catalyst to making even further customizations, allowing the user to create a website that better reflects their personal style, tastes, or business.

The schematic flow chart diagrams included are generally set forth as logical flow-chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow-chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

Various embodiments of the invention may be implemented at least in part in any conventional computer programming language. For example, some embodiments may be implemented in a procedural programming language (e.g., “C”, and the like), or in an object oriented programming language (e.g., “C++” “JAVA”, and the like). Other embodiments of the invention may be implemented as preprogrammed hardware elements (e.g., application specific integrated circuits, FPGAs, and digital signal processors), or other related components.

In some embodiments, the disclosed apparatus and methods (e.g., see the various flow charts described above) may be implemented as a computer program product for use with a computer system. Such implementation may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium.

The medium may be either a tangible medium (e.g., optical or analog communications lines) or a medium implemented with wireless techniques (e.g., WIFI, microwave, infrared or other transmission techniques). The series of computer instructions can embody all or part of the functionality previously described herein with respect to the system.

Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies.

Among other ways, such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). Of course, some embodiments of the invention may be implemented as a combination of both software (e.g., a computer program product) and hardware. Still other embodiments of the invention are implemented as entirely hardware, or entirely software.

The present invention has been described in terms of one or more preferred embodiments, and it should be appreciated that many equivalents, alternatives, variations, and modifications, aside from those expressly stated, are possible and within the scope of the invention.

We claim:

1. A method comprising:
providing, by at least one computer server, a website builder tool configured to enable a user to create at least one web page to be displayed on a display device;
providing, by the at least one computer server, a text entry user interface via the website builder tool, the text entry user interface enabling a user to input text content for the at least one web page via the website builder tool;
receiving, by the at least one computer server, text content from the user via the text entry user interface;
searching, by the at least one computer server, at least one image database to identify at least one proposed image corresponding to at least one of the following: at least one keyword within the text content, a language of the text content, a genre assigned to the at least one web page, and a geographical region associated with the at least one web page;
providing, by the at least one computer server, an image selection user interface via the website builder tool, the image selection user interface enabling a user to select at least one web page image as part of the at least one web page via the website builder tool; and
providing, by the at least one computer server, the at least one proposed image via the image selection user interface for selection by the user as the at least one web page image.

2. The method of claim 1, including scanning the text content by the at least one processing device to identify the at least one keyword.

3. The method of claim 1, including receiving from the user an indication of the geographical region associated with the at least one web page.

4. The method of claim 1, wherein the geographical region associated with the at least one web page is at least partially determined by the language of the text content.

5. The method of claim 1, including receiving from the user an indication of the genre assigned to the at least one web page.

6. The method of claim 1, wherein providing, by the at least one computer server, the at least one proposed image to the user for selection includes providing a pop-up prompt enabling the user to view the at least one proposed image and to select the at least one proposed image as the at least one web page image.

7. The method of claim 1, wherein searching at least one image database by the at least one computer server includes searching at least one image database provided by an online service other than the website builder tool.

8. The method of claim 1, including:
providing, by the at least one computer server, at least one template web page to be edited by the user via the website builder tool to create the at least one web page; and
enabling, by the at least one computer server, the user to alter the at least one template web page by at least one of the following:
adding the at least one proposed image to the at least one template web page, and
replacing at least one template image with the at least one proposed image.

9. A method comprising:
providing, by at least one computer server, a website builder tool configured to enable a user to create at least one web page to be displayed on a display device;
receiving, by the at least one computer server, text content from the user via a text entry user interface of the website builder tool;
searching, by the at least one computer server, at least one media database to identify at least one proposed media corresponding to the text content; and
providing, by the at least one computer server, the at least one proposed media via a media selection user interface for selection by the user for incorporation into the at least one web page.

10. The method of claim 9, including scanning the text content by the at least one processing device to identify the at least one keyword.

11. The method of claim 9, including receiving from the user an indication of a geographical region associated with the at least one web page and wherein the at least one proposed media corresponds to the geographical region.

12. The method of claim 9, including determining a geographical region associated with the at least one web page using a language of the text content and wherein the at least one proposed media corresponds to the geographical region.

13. The method of claim 9, including receiving from the user an indication of a genre assigned to the at least one web page and wherein the at least one proposed media corresponds to the genre.

14. The method of claim 9, wherein providing, by the at least one computer server, the at least one proposed media via the media selection user interface for selection by the user includes providing a pop-up prompt enabling the user to view the at least one proposed media and to select the at least one proposed media for incorporation into the at least one web page.

15. The method of claim 9, wherein searching the at least one media database by the at least one computer server includes searching at least one media database provided by an online service other than the website builder tool.

16. The method of claim 9, wherein the at least one proposed media includes at least one of an image, a video, an animation, and audio.

17. A system, comprising:
one or more computer server communicatively coupled to a network, the one or more computer server including a processor configured to perform the steps of:
providing, by at least one computer server, a website builder tool configured to enable a user to create at least one web page to be displayed on a display device;
receiving, by the at least one computer server, text content from the user via a text entry user interface of the website builder tool;
searching, by the at least one computer server, at least one media database to identify at least one proposed media corresponding to the text content; and
providing, by the at least one computer server, the at least one proposed media via a media selection user interface for selection by the user for incorporation into the at least one web page.

18. The system of claim 17, wherein the processor is configured to perform the steps of:
scanning the text content by the at least one processing device to identify the at least one keyword.

19. The system of claim 17, wherein the processor is configured to perform the steps of:
receiving from the user an indication of a geographical region associated with the at least one web page and wherein the at least one proposed media corresponds to the geographical region.

20. The system of claim 17, wherein the at least one proposed media includes at least one of an image, a video, an animation, and audio.
